(19) United States
(12) Patent Application Publication
(10) Pub. No.: US 2023/0349103 A1
(43) Pub. Date: Nov. 2, 2023

(54) CREPING ADHESIVES COMPRISING POLYELECTROLYTE COMPLEX

(71) Applicant: ECOLAB USA INC., St. Paul, MN (US)

(72) Inventors: Jia-Yu WANG, Naperville, IL (US); Mingli WEI, Naperville, IL (US); Gary Samuel FURMAN, JR., St. Charles, IL (US); Christopher D. KALEY, Hoffman Estates, IL (US)

(73) Assignee: ECOLAB USA INC., St. Paul, MN (US)

(21) Appl. No.: 18/303,879

(22) Filed: Apr. 20, 2023

Related U.S. Application Data
(60) Provisional application No. 63/336,551, filed on Apr. 29, 2022.

(51) Int. Cl. D21H 21/14

(52) U.S. Cl. CPC D21H 21/146

(57) ABSTRACT

The present application is directed to creping adhesives. The adhesive forms from a solution/dispersion of a polyelectrolyte complex that is composed of a mixture of one or more cationic polyelectrolytes, and one or more anionic polyelectrolytes. This adhesive complex offers several desirable features when compared to conventional, non-complex adhesives such as improved coating durability, wet tack and tunable coating softness, which are key properties for an adhesive to function as a creping adhesive.

### TECHNICAL FIELD

The present disclosure generally relates to creping adhesives and processes for making and using same. More particularly, the present disclosure relates to use of a polyelectrolyte complex as a creping adhesive and the methods for making and using same. The adhesive forms from a solution/dispersion of a polyelectrolyte complex, which comprises a mixture of one or more cationic polyelectrolytes and one or more anionic polyelectrolytes.

### BACKGROUND

The manufacture of paper is generally carried out by producing an aqueous slurry of cellulosic fibers, which also includes a variety of chemicals, and subsequently removing most of the water to form a thin paper web. The structural integrity of the paper arises in a large part from the mechanical entanglement of the cellulosic fibers in the web and hydrogen bonds that form between the cellulosic fibers. With paper intended for use as tissue and towel products, such as facial tissue, bathroom tissue, paper towels, and napkins, the level of structural integrity arising from the papermaking process conflicts somewhat with the degree of perceived softness that is necessary for consumer acceptance of such products. The most common method of increasing the perceived softness of tissue and towel products is to “crepe” the paper. The creping action can impart a fine, rippled texture to the sheet, increase the bulk of the sheet, and improve the softness and absorbency of the sheet. Creping can be accomplished by affixing the moist cellulosic paper web to a rotating, heated drum dryer, commonly known as a Yankee dryer, by applying the paper web onto the surface of the drum, which has been sprayed with a mixture of creping chemicals, which can include an adhesive, a modifier, a release agent, a phosphate, a humectant and potentially other processing or functional additives, usually in the form of an aqueous solution, emulsion, or dispersion. As the paper web dries, hydrogen bonds form between the fibers creating a flat and dense paper web. The dried paper web is then scraped backwardly upon itself and off the surface of the drum by means of a flexible blade that is called a “doctor” blade or a “creping” blade. This creping process causes a substantial number of inter-fiber bonds to break, altering the physical-chemical characteristics of the paper web and increasing the perceived bulkiness and softness of the resulting creped paper product.

The art of obtaining good creping quality relies on several key properties of creping adhesives. To achieve uniform creping for consistent sheet properties, the adhesive needs to be able to form a uniform coating with desirable softness at the application conditions. A coating which is too soft is too easily removed from the Yankee dryer surface, whereas a coating which is too hard causes too much build-up on the Yankee dryer surface and even unwanted chatter. In addition, the adhesive needs to be able to remain on the Yankee dryer surface and not to be dissolved or washed off under the repeated cycling of high moisture conditions. This adhesive property is referred to as film durability. Further, the adhesive needs to be able to provide sufficient wet tack for smooth transfer of the wet paper web onto the Yankee dryer surface, good adhesion between the wet paper sheet and the Yankee dryer surface for uniform drying, and sufficient peel adhesion at the creping blade for adequate breakup of fiber-to-fiber bonding and development of desirable sheet properties. Release and modifier aids are often used in combination with creping adhesives to fine-tune the adhesive properties, like softness and adhesion. They also provide lubrication to the doctor blade and influence the release of the paper web from the Yankee dryer surface. Nonetheless, the overall coating properties are dominantly dictated by the creping adhesive.

Over the years, various types of polymer resins have been employed as creping adhesives. This includes polyamidoamine-epihalohydrin (PAE), polyvinyl alcohol, polyethylenimine, polyvinylamine, polyamine, and polyvinylpyrrolidone. PAE is the most frequently used with the highest market volume. However, when a tissue paper making process involves low moisture/high temperature conditions, PAE tends to become very hard and brittle. This change in adhesive properties causes excessive adhesive build-up on the dryer surface and loss of tack, leading to many machine runnability issues. Considerable efforts have been spent trying to adjust the balance among the coating adhesion, softness, and durability to provide a wider machine operation window through a combination of one or more above adhesives with release and modifier aids. A drawback with these existing creping adhesives is that the coating properties are mainly set by the chemistry of each component. As a result, a creping adhesive, which generally has good adhesion and durability, tends to be too hard, especially at low creping moisture, whereas a softer creping adhesive with good adhesion tends to be less durable.

### BRIEF SUMMARY

The present disclosure provides an improved creping adhesive based on a polyelectrolyte complex. In particular, the present disclosure provides polyelectrolyte complexation as an additional parameter for tuning adhesive properties for a given creping process.

In some embodiments, a papermaking creping adhesive comprising a polyelectrolyte complex is provided herein. The papermaking creping adhesive includes an anionic polyelectrolyte and a cationic polyelectrolyte. The creping adhesive has several desirable features when compared to conventional, non-complex adhesives. The creping adhesives described herein exhibit improved coating durability, wet tack, and tunable coating softness through control over the level of complexation and its synergy with humectant, also referred to as plasticizer.

The anionic polyelectrolyte is selected from the group consisting of a sulfonated polyacrylamide, phosphonated polyacrylamide, carboxylated polyacrylamide, polyacrylic acid, sodium polyacrylate, sodium poly(styrenesulfonate), polyphosphate, lignosulfonate, carboxymethyl cellulose, and any combination thereof.

The cationic polyelectrolyte is selected from the group consisting of polyamidoamine, PAE, crosslinked polyamidoamine, poly(allylamine), poly(allylamine)-epihalohydrin, crosslinked poly(allylamine), polyethyleneimine, polyvinylpyrrolidone, chitosan, poly(diallyldimethyl ammonium chloride), hydrolyzed poly(n-vinyl formamide), cationic polyacrylamide, and any combination thereof.

In some aspects, the anionic polyelectrolyte has a weight average molecular weight of about 500 Da to about 1,500 kDa.

In some aspects, the cationic polyelectrolyte has a weight average molecular weight of about 500 Da to about 1,500 kDa.

In some aspects, the papermaking creping adhesive has a shear storage modulus of about 1.0×10⁵ Pa to about 5.0×10⁹ Pa at 100° C. with an adhesive retained moisture level of about 16% to 0%.

In some aspects, the creping adhesive comprises about 0.001 wt. % to about 99.9 wt. % of the anionic polyelectrolyte, and about 0.001 wt. % to about 99.9 wt. % of the cationic polyelectrolyte, based on a combined weight of the anionic polyelectrolyte, and the cationic polyelectrolyte.

In some aspects, the papermaking creping adhesive does not include a polyvinyl alcohol.

In some aspects, the adhesive contains a plasticizer, wherein the plasticizer is a water soluble polyol, glycol, glycerol, sorbitol, polyglycerin, polyethylene glycol, sugar, oligosaccharide, hydrocarbon oil, or any mixture thereof.

In some aspects, the anionic polyelectrolyte comprises a sulfonated polyacrylamide polymer, and the cationic polyelectrolyte comprises a PAE resin.

In some aspects, the PAE resin has a weight average molecular weight of about 25 kDa to about 1,500 kDa.

In some aspects, the anionic polyelectrolyte is a sulfonated polyacrylamide.

In some aspects, the sulfonated polyacrylamide is a copolymer comprising acrylamide and 2-acrylamido-2-methylpropane sulfonic acid (AMPS).

In some aspects, the sulfonated polyacrylamide comprises about 1 wt. % to about 99 wt. % of AMPS.

In some aspects, the anionic polyelectrolyte comprises a lignosulfonate.

In some aspects, the anionic polyelectrolyte is a copolymer comprising acrylate and acrylamide.

In some aspects, the anionic polyelectrolyte is a terpolymer containing acrylamide, AMPS, and phosphate esters of polyethylene glycol monomethacrylate.

A polyelectrolyte complex film is also provided. The polyelectrolyte complex film includes the papermaking creping adhesive described herein.

In some aspects, the polyelectrolyte complex film has a film insolubility of about 10% to about 95%.

In some aspects, the polyelectrolyte complex film has a wet tack of about 1 mJ to about 50 mJ.

The present disclosure also provides a polyelectrolyte complex film that includes an anionic polyelectrolyte and a cationic polyelectrolyte. The polyelectrolyte film comprises a film insolubility of about 10% to about 95%.

A process for drying a paper web is also provided. The process for drying a paper web includes applying a papermaking creping adhesive to a drying cylinder, pressing the paper web against the drying cylinder to adhere the paper web to the drying cylinder, and dislodging the paper web from the drying cylinder with a doctor blade, wherein the papermaking creping adhesive comprises a polyelectrolyte complex comprising an anionic polyelectrolyte, and a cationic polyelectrolyte.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings.

FIG. 1 shows shear storage modulus of Polymer A and Polymer B at the adhesive retained moisture range from 0 to 12%.

FIG. 2 shows shear storage modulus of blends of PAE/sulfonated polyacrylamide/glycerol at the adhesive retained moisture range from about 0 to about 12%.

FIG. 3 shows Film insolubility of blends of PAE/sulfonated polyacrylamide/glycerol.

FIG. 4 Wet tack of blends of PAE/sulfonated polyacrylamide/glycerol at adhesive retained moisture of ˜40%.

FIG. 5 shows film insolubility of blends of PAE/anionic polyacrylamide/glycerol with different anionic chemistry.

FIG. 6 shows shear storage modulus of Blend 9 and Blend 10 at the adhesive retained moisture range from 0 to 10%.

FIG. 7 shows shear storage modulus of Blend 6 and Blend 11 at the adhesive retained moisture range from 0 to 10%.

FIG. 8 shows shear storage modulus of polymer blends with and without addition of glycerol at the adhesive retained moisture range from 0 to 10%.

### DETAILED DESCRIPTION

A papermaking creping adhesive is provided herein. The papermaking creping adhesive includes one or more anionic polyelectrolytes, and one or more cationic polyelectrolytes.

Examples of anionic polyelectrolytes include, but are not limited to, sulfonated polyacrylamide, phosphonated polyacrylamide, carboxylated polyacrylamide, polyacrylic acid, sodium polyacrylate, sodium poly(styrenesulfonate), polyphosphate, lignosulfonate, carboxymethyl cellulose, or any combination thereof. In some aspects, the anionic polyelectrolyte is sulfonated polyacrylamide. In some aspects, the anionic polyelectrolyte is phosphonated polyacrylamide. In some aspects, the anionic polyelectrolyte is carboxylated polyacrylamide. In some aspects, the anionic polyelectrolyte is polyacrylic acid. In some aspects, the anionic polyelectrolyte is sodium polyacrylate. In some aspects, the anionic polyelectrolyte is sodium poly(styrenesulfonate). In some aspects, the anionic polyelectrolyte is polyphosphate. In some aspects, the anionic polyelectrolyte is lignosulfonate. In some aspects, the anionic polyelectrolyte is carboxymethyl cellulose. In some aspects, the anionic polyelectrolyte is an amphoteric polymer, wherein the net charge of the polymer is negative.

In some aspects, the anionic polyelectrolyte has a weight average molecular weight of about 500 Da to about 1,500 kDa, such as from about 500 Da to about 1,000 kDa, from about 500 Da to about 500 kDa, or from about 500 Da to about 100 kDa.

In some aspects, the sulfonated polyacrylamide is a copolymer comprising acrylamide and AMPS.

In some aspects, the sulfonated polyacrylamide comprises about 1 wt. % to about 99 wt. % of AMPS. In some aspects, the sulfonated polyacrylamide comprises about 10 wt. % to about 70 wt. % of AMPS, about 10 wt. % to about 60 wt. % of AMPS, about 20 wt. % to about 60 wt. % of AMPS, about 20 wt. % to about 60 wt. % of AMPS, about 20 wt. % AMPS, about 30 wt. % AMPS, about 40 wt. % AMPS, or about 50 wt. % AMPS.

In some aspects, the weight average molecular weight of the sulfonated polyacrylamide is about 20 kDa to about 100 kDa. In some aspects, the weight average molecular weight of the sulfonated polyacrylamide is about 20 kDa to about 90 kDa, about 30 kDa to about 90 kDa, about 30 kDa to about 80 kDa, about 30 kDa to about 70 kDa, about 40 kDa to about 90 kDa, about 40 kDa to about 80 kDa, about 40 kDa to about 70 kDa, about 50 kDa to about 90 kDa, about 50 kDa to about 80 kDa, about 50 kDa to about 70 kDa, about 55 kDa to about 70 kDa, about 60 kDa to about 65 kDa, or about 62 kDa.

In some aspects, the anionic polyelectrolyte comprises an anionic polyacrylamide. The anionic polyacrylamide can be a copolymer of acrylamide and other monomer(s) bearing an anionic group. Anionic groups include, but are not limited to, sulfonates, carboxylates, and phosphates.

In some aspects, the anionic polyelectrolyte comprises a lignosulfonate. In some aspects, the lignosulfonate has a chemical structure of formula I:

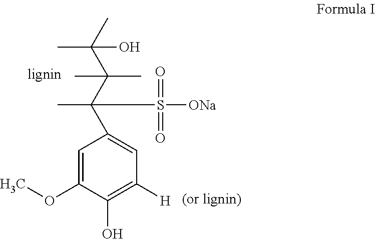

In some aspects, the weight average molecular weight of the lignosulfonate is about 20 kDa to about 60 kDa. In some aspects, the weight average molecular weight of the lignosulfonate is about 30 kDa to about 60 kDa. In some aspects, the weight average molecular weight of the lignosulfonate is about 45 kDa to about 60 kDa. In some aspects, the weight average molecular weight of the lignosulfonate is about 50 kDa to about 55 kDa.

In some aspects, the anionic polyelectrolyte comprises a copolymer comprising acrylate and acrylamide.

In some aspects, the anionic polyelectrolyte comprises a polyphosphate.

Examples of cationic polyelectrolytes include, but are not limited to, polyamidoamine, PAE, crosslinked polyamidoamine, poly(allylamine), poly(allylamine)-epihalohydrin, crosslinked poly(allylamine), polyethyleneimine, polyvinylpyrrolidone, chitosan, poly(diallyldimethyl ammonium chloride), hydrolyzed poly(n-vinyl formamide), cationic polyacrylamide, or any combination thereof. In some aspects, the cationic polyelectrolyte is polyamidoamine. In some aspects, the cationic polyelectrolyte is PAE. In some aspects, the cationic polyelectrolyte is polyamidoamine-epichlorohydrin. In some aspects, the cationic polyelectrolyte is crosslinked poly(allylamine). In some aspects, the cationic polyelectrolyte is poly(allylamine)-epihalohydrin). In some aspects, the cationic polyelectrolyte is crosslinked polyamidoamine. In some aspects, the cationic polyelectrolyte is polyethyleneimine. In some aspects, the cationic polyelectrolyte is polyvinylpyrrolidone. In some aspects, the cationic polyelectrolyte is chitosan. In some aspects, the cationic polyelectrolyte is poly(diallyldimethyl ammonium chloride). In some aspects, the cationic polyelectrolyte is a hydrolyzed poly(n-vinyl formamide). In some aspects, the cationic polyelectrolyte is a cationic polyacrylamide. In some aspects, the cationic polyelectrolyte is an amphoteric polymer, wherein the net charge of the polymer is positive.

In some embodiments, the epihalohydrin of PAE can include, but is not limited to, epichlorohydrin, epibromohydrin, epiiodohydrin, or any mixture thereof. In some embodiments, the epihalohydrin is epichlorohydrin.

Suitable polyamidoamines can be prepared by reacting one or more polyamines, e.g., a polyalkylene polyamine, and one or more dicarboxylic acids (diacids) and/or a corresponding dicarboxylic acid halide or diester thereof. For example, the polyamidoamine can be made by reacting one or more polyalkylene polyamines and one or more polycarboxylic acids.

In some embodiments, the polyalkylene polyamine can be or can include, but is not limited to, ethylenediamine, diethylenetriamine, triethylenetetramine, aminoethyl piperazine, tetraethylenepentamine, pentaethylenehexamine, N-(2-am inoethyl)piperazine, N,N′-bis(2-aminoethyl)-ethylenediamine, diaminoethyl triaminoethylamine, piperazinethyl triethylenetetramine, or any mixture thereof. In some embodiments, the polycarboxylic acid can be succinic acid, glutaric acid, 2-methylsuccinic acid, adipic acid, pimelic acid, suberic acid, azelaic acid, sebacic acid, undecanedioic acid, dodecandioic acid, 2-methylglutaric acid, 3,3-dimethylglutaric acid, tricarboxypentanes, e.g., 4-carboxypimelic, alicyclic saturated acids, e.g., 1,2-cyclohexanedicarboxylic, 1-3-cyclohexanedicarboxylic, 1,4-cyclohexanedicarboxylic, and 1-3-cyclopentanedicarboxylic, unsaturated aliphatic acids, e.g., maleic acid, fumaric acid, itaconic acid, citraconic acid, mesaconic acid, aconitic acid, and hexane-3-diotic acid; unsaturated alicyclic acids, e.g., 1,4-cyclohexenedicarboxylic; aromatic acids, e.g., phthalic acid, isophthalic acid, terephthalic acid, 2,3-naphthalenedicarboxylic acid, and benzene-1,4-diacetic acid; and heteroaliphatic acids, e.g., diglycolic acid, thiodiglycolic acid, dithiodiglycolic acid, iminodiacetic acid, and methyliminodiacetic acid; salts thereof; esters thereof; hydrates thereof; isomers thereof; or any mixture thereof. In some embodiments, the diester can include dimethyl glutarate, dimethyl adipate, dimethyl succinate, or any mixture thereof.

In some embodiments, the polyamidoamine can be produced by heating a mixture of a dicarboxylic acid and the polyamine to a temperature of about 110° C. to about 250° C. For example, the mixture of the dicarboxylic acid and the polyamine can be heated to a temperature of about 110° C., about 125 ° C., about 140° C. to about 160° C., about 175° C., about 190° C., or about 200° C. at atmospheric pressure. In some embodiments the reaction between the polyamine and the dicarboxylic acid can be carried out under a reduced pressure and the reaction temperature can be reduced to about 75° C. to about 150° C. The time of reaction can depend, at least in part, on the temperature and/or pressure and can generally be from about 0.5 hours to about 4 hours. The reaction can be continued to substantial completion. The reaction between the first polyamine and the first dicarboxylic acid can produce water as a byproduct, which can be removed by distillation. At the end of the reaction, the resulting product can be dissolved or dispersed in water to provide any desired concentration, such as an aqueous polyamidoamine resin having about 50 wt. % total resin solids.

In carrying out the reaction between the polyamine and the dicarboxylic acid, the amount of the dicarboxylic acid can be sufficient to react substantially completely with the primary amine groups of the polyamine but insufficient to substantially react with the secondary amine groups of the polyamine. In some embodiments, the molar ratio of the polyamine to the dicarboxylic acid can be from a low of about 0.8:1, about 0.85:1, about 0.9:1, about 0.95:1, or about 1:1 to a high of about 1:1, about 1.05:1, about 1.1:1, about 1.2:1, about 1.3:1, or about 1.4:1.

In other aspects, an ester of a dicarboxylic acid can be used instead of dicarboxylic acid for reaction with the polyamine and the reaction can be conducted at a lower temperature, such as about 100° C. to about 175° C. at atmospheric pressure. If the reaction between the polyamine and the diester is carried out under a reduced pressure the reaction temperature can be reduced to about 75° C. to about 150° C. In this case, the byproduct can be an alcohol, the type of alcohol depending upon the identity of the diester. For example, if a dimethyl ester is used as a reactant, the alcohol byproduct can be methanol. The molar ratio between the polyamine and the diester can be the same as the ratio between the polyamine and the dicarboxylic acid.

In some embodiments, the creping adhesive can be produced or synthesized according to a first synthesis process as described in U.S. Pat. Nos. 8,066,847, 9,611,590, US 2018/0179427, and U.S. Pat. No. 10,472,549, the contents of which are expressly incorporated by reference into the present disclosure. The first synthesis process can include reacting the polyamidoamine and the functionally symmetric crosslinker (the first crosslinker) in the presence of the solvent to produce a prepolymer that can include polyamidoamine backbones crosslinked by primary crosslinking moieties. The prepolymer and the epihalohydrin (the second crosslinker) can be reacted in the presence of the solvent to produce the crosslinked resin that can include polyamidoamine backbones crosslinked by primary crosslinking moieties and propanediyl moieties.

In other embodiments, the creping adhesive can be produced or synthesized according to a second synthesis process. The second synthesis process can include reacting the polyamidoamine and the functionally symmetric cross linker (the first crosslinker) in the presence of the solvent to produce the prepolymer that can include the polyamidoamine backbones crosslinked by primary crosslinking moieties. The prepolymer and the epihalohydrin (the second crosslinker) can be reacted in the presence of the solvent to produce the crosslinked resin that can include polyamidoamine backbones crosslinked by primary crosslinking moieties and propanediyl moieties.

The polyamidoamine and the functionally symmetric crosslinker can be reacted in the presence of the solvent at a temperature of about 30° C., about 35° C., or about 40° C. to about 80° C., about 90° C., or about 100° C. to produce the prepolymer. The polyamidoamine and the functionally symmetric crosslinker can be reacted in the presence of the solvent or in the presence of the solvent for about 30 minutes, about 1 hour, about 2 hours, or about 4 hours to about 6 hours, about 8 hours, about 10 hours, or about 12 hours to produce the prepolymer. In some embodiments, during reaction the reaction mixture can be agitated, e.g., stirred.

The prepolymer and the epihalohydrin can be reacted in the presence of the solvent at a temperature of about 40° C., about 45° C., about 50° C., or about 55° C. to about 80° C., about 85° C., or about 90° C. to produce the crosslinked resin. The prepolymer and the epihalohydrin can be reacted in the presence of the solvent for about 30 minutes, about 1 hour, about 2 hours, or about 4 hours to about 6 hours, about 8 hours, or about 10 hours to produce the crosslinked resin. In some aspects, during reaction the reaction mixture can be agitated, e.g., stirred.

In some aspects, the PAE resin has a weight average molecular weight of about 25 kDa to about 1,500 kDa, such as from about 25 kDa to about 1,200 kDa, about 25 kDa to about 900 kDa, from about 25 kDa to about 500 kDa, from about 50 kDa to about 1,500 kDa, from about 75 kDa to about 1,500 kDa, from about 100 kDa to about 1,500 kDa, from about 300 kDa to about 1,500 kDa, from about 500 kDa to about 1,500 kDa, from about 700 kDa to about 1,500 kDa, from about 900 kDa to about 1,500 kDa, or from about 1,100 kDa to about 1,500 kDa.

The weight average molecular weight can be determined using size exclusion chromatography coupled with a multiangle light scattering detector (SECMALS). A series of SEC columns, e.g., TSKgel PWXL-CP (Tosoh Bioscience), can be used to separate polymers of different hydrodynamic radius. The SEC-MALS method uses an aqueous mobile phase containing salt and buffer. Two detectors are used, including a MALS detector (HELEOS-II, WYATT TECHNOLOGY) and a differential refractometer detector (Optilab T-rEX, WYATT TECHNOLOGY). The SEC-MALS technique for measuring the weight average molecular weight of a polymer is well understood by those skilled in the art.

In some aspects, the adhesive comprises a plasticizer, wherein the plasticizer is a water-soluble polyol, glycol, glycerol, sorbitol, polyglycerin, polyethylene glycol, sugar, oligosaccharide, hydrocarbon oil, or any mixture thereof.

In some aspects, the papermaking creping adhesive has a shear storage modulus of about 1.0×10⁵ to about 5.0×109 Pa at 100° C. with a retained moisture level of about 16% to about 0%. In some aspects, the papermaking creping adhesive has a shear storage modulus of about 1.5×10⁶ to about 1.0×10⁸ Pa at 100° C. with a retained moisture level of about 1% to about 0%. In some aspects, the papermaking creping adhesive has a shear storage modulus of about 1.5×10⁶ to about 1.5×10⁷ Pa at 100° C. with a retained moisture level of about 2% to about 0%. In some aspects, the papermaking creping adhesive has a shear storage modulus of about 1.5×10⁶ to about 1.0×10⁷ Pa at 100° C. with a retained moisture level of about 4% to about 0%. In some aspects, the papermaking creping adhesive has a shear storage modulus of about 1.5×10⁶ to about 1.0×10⁷ Pa at 100° C. with a retained moisture level of about 4% to about 2%. In some aspects, the papermaking creping adhesive has a shear storage modulus of about 1.0×10⁶ to about 1.0×10⁷ Pa at 100° C. with a retained moisture level of about 6% to about 4%. In some aspects, the papermaking creping adhesive has a shear storage modulus of about 1.0×10⁶ to about 1.5×10⁶ Pa at 100° C. with a retained moisture level of about 10% to about 6%. In some aspects, the papermaking creping adhesive has a shear storage modulus of about 1.0×10⁶ to about 1.2×10⁷ Pa at 100° C. with a retained moisture level of about 12% to about 10%.

In some aspects, the papermaking creping adhesive comprises a about 0.001 wt. % to about 99.9 wt. % of the anionic polyelectrolyte, and about 0.001 wt. % to about 99.9 wt. % of the cationic polyelectrolyte, based on a combined weight of the anionic polyelectrolyte, and the cationic polyelectrolyte.

The papermaking creping adhesive can have or can be adjusted to have a pH of about 4, about 4.5, about 5, about 5.5, about 6, about 6.5, or about 7 to about 8, about 9, about 10, or about 10.5. In some aspects, the pH of the creping adhesive can be adjusted to about 7 to about 9. Any suitable acid, e.g., sulfuric acid, or any suitable base, e.g., sodium hydroxide, can be added to the creping adhesive to adjust the pH to a desired pH value. In some embodiments, one or more multifunctional acids can be used to adjust the pH of the papermaking creping adhesive. Suitable multifunctional acids include, but are not limited to, oxalic acid, malonic acid, succinic acid, glutaric acid, adipic acid, pimelic acid, suberic acid, azelaic acid, sebacic acid, phthalic acid, isophthalic acid, terephthalic acid, citric acid, isocitric acid, aconitic acid, carballylic acid, glycolic acid, lactic acid, malic acid, tartaric acid, gluconic acid, maleic acid, fumaric acid, ascorbic acid, aspartic acid, glutamic acid, 4-hydroxy-benzoic acid, 2,4-dihydroxy benzoic acid, sulfamic acid, methanesulfonic acid, 4-toluene sulfonic acid, xylene sulfonic acid, phenol sulfonic acid, or any mixture thereof. In some embodiments, the acid can be, but is not limited to, one or more mineral acids, e.g., sulfuric acid, hydrochloric acid, nitric acid, phosphoric acid, boric acid, hydrofluoric acid, or any mixture thereof.

The papermaking creping adhesive can have or can be adjusted to have a viscosity of about 20 cP, about 50 cP, about 100 cP, or about 250 cP to about 500 cP, about 650 cP, about 800 cP, about 900 cP, about 1,000 cP, or about 1,200 cP at a temperature of about 25° C. The viscosity of the papermaking creping adhesive can be measured with a Brookfield viscometer, e.g., Brookfield DV-E Viscometer, #61/62 spindle at 60 rpm.

The papermaking creping adhesive can have an adhesion of about 25 gram-force per inch, about 50 gram-force per inch, about 100 gram-force per inch, or about 250 gram-force per inch to about 500 gram-force per inch, about 600 gram-force per inch, about 700 gram-force per inch, or about 800 gram-force per inch.

The papermaking creping adhesive can be single phase stable. The papermaking creping adhesive is determined to be single phase stable when the papermaking creping adhesive does not form a visible interface after 24 hours when allowed to rest at room temperature. In some aspects, the papermaking creping adhesive can be single phase stable for at least 1 day, at least 2 days, at least 3 days, at least 5 days, at least 10 days, at least 30 days, at least 45 days, at least 60 days, at least 75 days, or at least 90 days.

In some aspects, the papermaking creping adhesive does not include a polyvinyl alcohol. In some aspects, the papermaking creping adhesive consists of an anionic polyelectrolyte, a cationic polyelectrolyte, and a solvent. In other aspects, a polyvinyl alcohol is not added to the pulp, paper surface, or Yankee dryer.

In some aspects, the papermaking creping adhesive can also include one or more functional additives and/or be used in conjunction with one or more functional additives in a paper making process to produce a paper product. The functional additive(s) includes, but is not limited to, one or more plasticizers, one or more re-wetting agents, one or more release aids, one or more tackifiers, one or more surfactants, one or more dispersants, one or more salts that can adjust water hardness, one or more acids or one or more bases that can adjust the pH of the creping adhesive, one or more phosphate salts, one or more cationic surfactants or silicone/siloxane to impart softness to the tissue paper, or any mixture thereof. In other aspects, the one or more additives can be used in conjunction with the creping adhesive but can be applied to a surface of a creping cylinder separately rather than being mixed with the creping adhesive.

Suitable plasticizers include, but are not limited to, water-soluble polyols, glycols, glycerol, sorbitol, polyglycerin, polyethylene glycols, sugars, oligosaccharides, hydrocarbon oils, or any mixture thereof.

Suitable re-wetting agents include, but are not limited to, one or more protonated amines, one or more protonated polyamines, one or more quaternary ammonium salts, one or more poly-quaternary ammonium salts, glycerin, one or more salts of a polycarboxylic acid neutralized with triethanolamine, one or more phosphates, choline chloride, or any mixture thereof. Suitable protonated amines and protonated polyamines include, but are not limited to, amines and polyamines protonated with one or more inorganic and/or one or more organic acids, such as lactic acid, citric acid, lactobionic acid, or any mixture thereof. Suitable quaternary ammonium salts include, but are not limited to, diallyldimethylammonium chloride (DADMAC). Suitable poly-quaternary ammonium salts include, but are not limited to, poly-diallyldimethylammonium chloride (poly-DADMAC).

The phosphate can be phosphoric acid or phosphate salts. Suitable phosphate salts include, but are not limited to, monoammonium phosphate, Diammonium phosphate, potassium pyrophosphate, or any mixture thereof.

Suitable release aids can be based on a quaternary imidazoline (e.g., methyl and ethyl sulfate salts of quaternary imidazoline derived from fatty acids), one or more mineral oils, one or more vegetable oils, one or more silicon oils, one or more surfactants, one or more soaps, one or more polyols, glycols, glycerol, sorbitol, polyglycerin, polyethylene glycol, sugars, oligosaccharides, hydrocarbon oils, or any mixture thereof.

The amount of each additive that can optionally be in the papermaking creping adhesive or used separately can independently be about 0.1 wt. %, about 0.5 wt. %, about 1 wt. %, about 3 wt. %, about 5 wt. %, or about 7 wt. % to about 15 wt. %, about 20 wt. %, about 25 wt. %, or about 30 wt. %, based on a combined weight of the papermaking creping adhesive. For example, the papermaking creping adhesive can include from about 1 wt. % to about 30 wt. %, about 5 wt. % to about 15 wt. %, about 2 wt. % to about 8 wt. %, about 6 wt. % to about 20 wt. %, about 10 wt. % to about 24 wt. %, about 16 wt. % to about 28 wt.

%, or about 18 wt. % to about 30 wt. % of the re-wetting agent, based on the combined weight of the papermaking creping adhesive.

A polyelectrolyte complex film is also provided. The polyelectrolyte complex film includes the papermaking creping adhesive described herein.

In some aspects, the polyelectrolyte complex film has a film insolubility of about 10% to about 95%. In some aspects, the polyelectrolyte complex film has a film insolubility of about 30% to about 95%, about 40% to about 95%, about 45% to about 90%, about 50% to about 90%, about 30% to about 80%, about 30% to about 75%, about 30% to about 70%, about 30% to about 65%, about 40% to about 80%, about 40% to about 75%, about 40% to about 70%, about 40% to about 65%, about 50% to about 80%, about 50% to about 75%, about 50% to about 70%, or about 50% to about 65%.

The film insolubility of the papermaking creping adhesive can be measured according to the following procedure. A papermaking creping adhesive is applied uniformly on the paper substrate, dried in an oven at about 105° C. for one hour, and then weighed. The paper substrate and dried film is placed in a jar containing water at about 50° C. and subjected to constant stirring for an hour. The paper substrate is dried one more time at 105° C. for two hours and weighed. After correcting for the mass of the paper substrate without the film, the mass of the film that goes in solution may be determined as a percentage of the mass of the original dry film. The range of the film insolubility goes from 0 to 100%, with the higher the percentage corresponding to a greater amount of the papermaking creping adhesive that dissolved in the water.

In some aspects, the polyelectrolyte complex film has a wet tack of about 1 mJ to about 50 mJ. In some aspects, the polyelectrolyte film has a wet tack of about 2 mJ to about 50 mJ, about 4 mJ to about 50 mJ, about 5 mJ to about 50 mJ, about 1 mJ to about 40 mJ, about 1 mJ to about 30 mJ, about 1 mJ to about 25 mJ, about 1 mJ to about 20 mJ, about 1 mJ to about 18 mJ, about 1 mJ to about 16 mJ, about 1 mJ to about 14 mJ, about 1 mJ to about 12 mJ, about 2 mJ to about 40 mJ, about 2 mJ to about 30 mJ, about 2 mJ to about 25 mJ, about 2 mJ to about 20 mJ, about 2 mJ to about 18 mJ, about 2 mJ to about 16 mJ, about 2 mJ to about 14 mJ, about 2 mJ to about 12 mJ, about 4 mJ to about 40 mJ, about 4 mJ to about 30 mJ, about 4 mJ to about 25 mJ, about 4 mJ to about 20 mJ, about 4 mJ to about 18 mJ, about 4 mJ to about 16 mJ, about 4 mJ to about 14 mJ, or about 4 mJ to about 12 mJ.

In some aspects, a polyelectrolyte complex film includes an anionic polyelectrolyte and a cationic polyelectrolyte with a film insolubility of about 10% to about 95%, such as about 20% to about 95%, about 30% to about 95%, about 40% to about 95%, about 50% to about 95%, about 60% to about 95%, about 70% to about 95%, about 80% to about 95%, or about 90% to about 95%.

The papermaking creping adhesive can be used in a paper making process to produce a creped paper product. Illustrative creped paper products include, but are not limited to, facial tissue, bathroom tissue, paper towels, and napkins.

A process for drying a paper web is provided. The process for drying a paper web includes applying to a drying cylinder a papermaking creping adhesive; pressing the paper web against the drying cylinder to adhere the paper web to the drying cylinder; and dislodging the paper web from the drying cylinder with a doctor blade, wherein the papermaking dryer comprises a solvent, a polyelectrolyte complex comprising an anionic polyelectrolyte, and a cationic polyelectrolyte.

The paper making process can include taking a slurry of papermaking fibers at a consistency of about 0.05 wt. % to about 1 wt. % and dewatering the slurry to form a paper web with a final consistency of about 95-99 wt. %. In some embodiments, the slurry can be dewatered via a series of different processes that include, but are not limited to, inertial dewatering (early forming section of the machine), press dewatering (press section of the machine), and/or thermally evaporating the water (dryer section of the machine). In some paper making machines, through-air drying cylinders can be located after the forming section and before the dryer section. The papermaking fibers can be formed into a paper web. For example, the papermaking fibers can be deposited onto a foraminate surface to form the paper web.

The creping adhesive can be applied to a drying surface, e.g., a surface of a rotating Yankee dryer. The paper web can be pressed against the drying surface and adhered thereto via the papermaking creping adhesive. The paper web can be dislodged from the rotating Yankee dryer, e.g., with a doctor blade, to produce a paper product.

The doctor blade can scrape the paper web backwardly upon itself and off of the drying surface. This creping process can cause a substantial number of inter-fiber bonds to break that can alter the physical-chemical characteristics of the paper web and increase the perceived softness of the resulting paper product.

In some aspects the papermaking creping adhesive and one or more additives can be applied to the drying surface as a mixture or separately. If two or more components are separately applied to the drying surface, the two or more components can be applied in any order or sequence with respect to one another or at the same time with respect to one another. For example, a mixture of the papermaking creping adhesive and a re-wetting agent can be applied to the drying surface and a release aid can be applied to the drying surface, before, after, or simultaneously with respect to the mixture of the papermaking creping adhesive and the re-wetting agent, as opposed for forming a mixture of all three components prior to application to the drying surface.

In some aspects, the drying surface can be the surface of a Yankee dryer. The Yankee dryer is a large diameter cylinder. The Yankee dryer can be a cylinder having an internal diameter of about 2.5 m to about 6 m. The drum can be heated with high-pressure steam or other heated medium to provide a hot or heated drying surface. For example, the surface of the cylinder can be heated to a temperature of about 20° C., about 30° C., about 40° C., about 60° C., about 80 ° C., or about 100° C. to about 120° C., about 140° C., about 160° C., about 180° C., about 200° C., or about 220° C. The fiber web can be heated on the drying surface for a time of about 0.5 seconds to about 1 minute. As such, the paper web can be heated to a temperature of about 20° C., about 30° C., about 40° C. to about 60° C., about 80° C., or about 100° C. to about 120° C., about 140° C., about 160° C., about 180° C., or about 200° C. when adhered to the surface of the cylinder.

In some aspects, the papermaking fibers can be derived from bleached furnish, softwood, hardwood, paper pulp, mechanical pulp, or any mixture thereof. In some aspects, the fibers can include non-wood fibers, such as cotton fibers or cotton derivatives, abaca, kenaf, sabai grass, flax, esparto grass, straw, jute, hemp, bagasse, milkweed floss fibers, and pineapple leaf fibers; and wood fibers such as those obtained from deciduous and coniferous trees, including softwood fibers, such as northern and southern softwood kraft fibers; hardwood fibers, such as eucalyptus, maple, birch, aspen, or any mixture thereof. In some aspects, the fibers can be or can include fibers recovered from previously manufactured fiber products. In other words, the fibers can be or can include recycled fibers. The fibers can be liberated from the source material by any of a number of well-known mechanical and/or chemical processes such as sulfate, sulfite, polysulfide, and/or soda pulping. The pulp can be bleached if desired by chemical means including the use of chlorine, chlorine dioxide, oxygen, ozone, hydrogen peroxide, alkaline metal peroxide, alkaline earth metal peroxides, as well as other compounds. In some embodiments, the plurality of fibers can be a mixture of softwood and hardwood fibers.

The papermaking creping adhesive can be applied to the surface of the rotating Yankee dryer or creping cylinder at a rate, relative to the rate of dryer surface rotation, which can provide an adequate amount of adhesive to hold the paper web during drying yet release the dried web upon completion of drying via contact with the doctor blade. The application rate of the papermaking creping adhesive on the surface of the rotating Yankee dryer or creping cylinder can be about 0.5 mg/m², about 1 mg/m², about 3 mg/m², about 5 mg/m², about 7 mg/m², about 9 mg/m², or about 10 mg/m², to about 12 mg/m², about 15 mg/m², about 20 mg/m², about 25 mg/m^{2, 30} mg/m², about 40 mg/m², about 50 mg/m², about 70 mg/m², about 100 mg/m², about 150 mg/m², about 200 mg/m², about 250 mg/m², about 300 mg/m^{2, 400} mg/m², about 500 mg/m², or greater.

The papermaking creping adhesive applied to the surface of the Yankee dryer can form a layer, film, or coating on the surface having a thickness of about 0.1 μm, about 1 μm, about 50 μm, about 100 μm, about 125 μm, about 150 μm, about 175 μm, about 200 μm, about 250 μm, about 300 μm, about 350 pm, about 400 μm, about 450 μm, or about 500 μm.

The papermaking creping adhesive can be applied onto the surface of the Yankee dryer, to provide a coating that can develop a crepe ratio of at least −2%, at least −1° A, at least 0%, at least 1%, at least 2%, at least 3%, at least 4%, at least 5%, at least 6%, or at least 7%. For example, the papermaking creping adhesive can be applied onto the drying surface, e.g., a surface of a Yankee dryer, to provide a coating that can develop a crepe ratio of about −2%, about −1%, about 0%, about 1%, about 3%, about 5%, about 7%, about 9%, about 10% to about 12%, about 14%, about 16%, about 18%, about 20%, about 22%, about 24%, about 26%, about 28%, about 30%, about 32%, about 34%, or about 36%. In other aspects, the papermaking creping adhesive can be applied onto the drying surface, e.g., a surface of a Yankee dryer, to provide a coating that can develop a crepe ratio of about −2% to about 36%, about −2% to about 32%, about 10% to about 36%, about 1% to about 26%, about 12% to about 20%, or about 0% to about 10%. As used herein, the term “crepe ratio” is equal to [(Yankee velocity−reel velocity)/Yankee velocity]×b 100.

The creped paper product can have a basis weight of about 10 g/m², about 20 g/m², or about 25 g/m² to about 30 g/m², about 40 g/m², or about 50 g/m². The density of the creped paper product can be about 0.03 g/m³, about 0.05 g/cm³, about 0.1 g/cm³ to about 0.2 g/cm³, about 0.4 g/cm³, or about 0.6 g/cm³.

### EXAMPLES

In order to provide a better understanding of the foregoing discussion, the following non-limiting examples are offered. Although the examples can be directed to specific embodiments, they are not to be viewed as limiting the invention in any specific respect.

The charge density (Mütek) of the polyelectrolyte in the present invention were measured using a colloid titration method. Charge density (meq/g) is the amount of charge per unit weight, in milliequivalents per gram of product solids. The anionic polyelectrolyte samples are titrated with poly-DADMAC and the cationic polyelectrolyte samples are titrated with potassium polyvinyl sulfate (PVSK) to a 0 mV potential with an auto titrator (Brinkmann Titrino) at a fixed titration rate and a Mütek particle charge detector is used for end point detection.

To control the film retained moisture level, the same samples were annealed at about 105° C. for different periods. Right after each thermal treatment, the mass of the sample was monitored using a four decimal analytical balance. The moisture level was calculated by mass difference between moisture retained and 100% dry sample over the sample mass, that is, moisture %=(M−M_{dry})/MX100%.

To measure film solubility, the initial weight of 1″×2″ dry strip was recorded and then 1 ml blend solution was applied to the strip evenly. The strip was dried at about 105° C. for about 1 hour and then the total weight of the dry coated strip was recorded (Oven dry wt). The dry coated strip was placed in a jar that was preheated to about 50° C. in the incubator. The shaker was turned on and the jar remained in the shaker/incubator for about 1 hour. The strip was removed from the jar and dried at about 105° C. for at least about 2 hours. The strip was weighed (final wt). Film insolubility was calculated by equation (1)

$$\% Insolubility = \frac{( Final wt - Initial wt )}{( Oven Dry wt - Initial Wt )} * 100 \qquad ( 1 )$$

Wet tack analysis was measured using Anton Parr modular compact Rheometer (MCR302) in parallel plate geometry at 100° C. The adhesive blend solution was dried to retain target moisture at 105° C. for a certain period and then it was applied onto the surface of the upper plate. The measuring system was operated so that the upper plate was lowered and positioned in contact with the bottom plate with the adhesive in between. A constant normal force, 1 N, was applied to the bottom plate for 20 seconds. Then the top plate was pulled up with a speed of 5,000 μm/s with a separation gap of 50 mm and the pull up force was measured and the energy to separate the two plates is accumulated under the force curve.

All shear modulus measurements were carried out using an Anton-Paar modular compact rheometer (MCR302) under the parallel plate geometry at 100° C. Typical shear modulus measurements were taken by a frequency sweep from 100 to 1 rad/s with shear strain of 0.03%. To avoid moisture loss during the measurement, a Peltier-temperature-controlled hood was employed, and the sample was limited to be held at 100° C. for 10 s before the frequency sweep started. During the frequency sweep, shear storage modulus, shear loss modulus and phase angle were monitored but only shear storage modulus at frequency of 70.2 rad/s which was about 11 Hz was used for comparing film softness of each adhesive.

Table 1 summarizes the chemicals used in the examples.

TABLE 1

| Sam- | | Charge | |
|---|---|---|---|
| ple | | density | Mw |
| ID | Chemistry | (meq/g) | (kDa) |
| A | Polyvinyl alcohol/poly(2-acrylamido-2-methyl- | −0.76 | 50 to |
| | 1-propanesulfonic acid sodium salt) copolymer | | 100 |
| B | polyacrylamide/poly(2-acrylamido-2-methyl-1- | −0.95 | 300 |
| | propanesulfonic acid sodium salt) copolymer | | |
| C | polyacrylamide/poly(2-acrylamido-2-methyl-1- | −0.95 | 56 |
| | propanesulfonic acid sodium salt) copolymer | | |
| D | polyacrylamide/poly(2-acrylamido-2-methyl-1- | −1.47 | 62 |
| | propanesulfonic acid sodium salt) copolymer | | |
| E | polyacrylamide/poly(2-acrylamido-2-methyl-1- | −1.90 | 64 |
| | propanesulfonic acid sodium salt) copolymer | | |
| F | polyacrylamide/poly(2-acrylamido-2-methyl-1- | −2.36 | 70 |
| | propanesulfonic acid sodium salt) copolymer | | |
| G | Polyacrylamide/poly(acrylic acid sodium salt) | −1.73 | 60 |
| | copolymer | | |
| H | polyacrylamide/poly(2-acrylamido-2-methyl-1- | −1.00 | 50 |
| | propanesulfonic acid sodium | | |
| | salt)/poly(phosphate esters of polyethylene | | |
| | glycol monomethacrylate) terpolymer | | |
| I | Lignosulfonic acid sodium salt | −1.32 | 52 |
| J | Polyamidoamine | 2.01 | 1.5 |
| K | PAE | 2.7 | 500 to |
| | | | 800 |
| L | Polyacrylamide | — | 60K |
| M | Glycerol | — | 92.09 |

Table 2 summarizes the composition of the blends used in the examples.

TABLE 2

| | | wt % of | wt % of | |
|---|---|---|---|---|
| Sample | Compo- | cationic | anionic | wt % of |
| ID | sition | polyeletrolyte | polyeletrolyte | humectant |
| Blend 1 | K + L + M | 49.8 | 33.2* | 17 |
| Blend 2 | K + C + M | 49.8 | 33.2 | 17 |
| Blend 3 | K + D + M | 49.8 | 33.2 | 17 |
| Blend 4 | K + E + M | 49.8 | 33.2 | 17 |
| Blend 5 | K + F + M | 49.8 | 33.2 | 17 |
| Blend 6 | K + A + M | 49.8 | 33.2 | 17 |
| Blend 7 | K + G + M | 49.8 | 33.2 | 17 |
| Blend 8 | K + H + M | 49.8 | 33.2 | 17 |
| Blend 9 | K + I + M | 49.8 | 33.2 | 17 |
| Blend 10 | K + M | 83 | 0 | 17 |
| Blend 11 | J + D + M | 49.8 | 33.2 | 17 |
| Blend 12 | K + L | 60 | 40* | 0 |
| Blend 13 | K + F | 60 | 40 | 0 |

*Polymer L is a non-ionic polymer

### Example 1

### Comparison of Sulfonated Polyacrylamide with Sulfonated Polyvinyl Alcohol (PVOH)

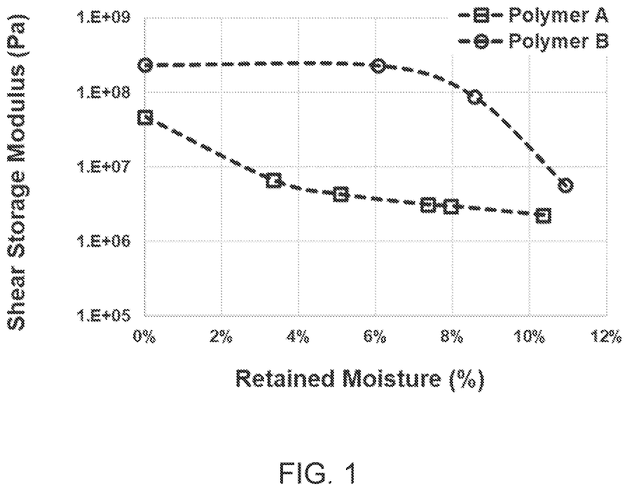

FIG. 1 shows shear storage modulus of Polymer A and Polymer B at the adhesive retained moisture range from 0 to 12%. At the retained moisture less than 6%, sulfonated polyacrylamide (Polymer B) was much harder than sulfonated PVOH (Polymer A) and its softness exhibits little sensitivity to the moisture change. At the retained moisture between 6% and 12%, it is still much harder than sulfonated PVOH, but its softness also becomes highly sensitive to the moisture change. These characteristics of sulfonated polyacrylamide makes it unfavorable as a creping adhesive. It should be noted that film softness of the two vinyl polymers at this moisture range is dominated by their vinyl backbone chemistry and the side chain of the sulfonated groups has little influence on material softness.

### Example 2

### Comparison of Properties of Polyelectrolyte Complex Composed of PAE and Sulfonated Polyacrylamide

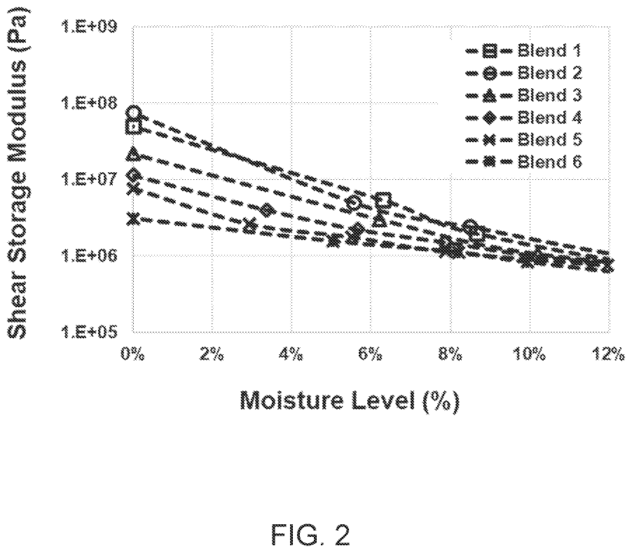

FIG. 2 shows shear storage modulus of 6 polymer blends at the adhesive retained moisture range from 0 to 12%. This data provides a comparison of film softness of polyelectrolyte complex composed of PAE and sulfonated polyacrylamide (Blend 2 to 5) with non-complex adhesive (Blend 1) as well as polyelectrolyte complex composed of PAE and sulfonated PVOH (Blend 6). The blend 1 was made of PAE, polyacrylamide, and glycerol. It is a non-complex adhesive blend and appears hardest among the 6 blends in the test retained moisture range. Blends 2 to 5 were made of PAE, glycerol and sulfonated polyacrylamide with increased charged density. These are blends of polyelectrolyte complex and the level of complexation increases with charge density of sulfonated polyacrylamide. The four blends all appear softer than Blend 1 and their softness ranks by Blend 5 >Blend 4 >Blend 3 >Blend 2, which is consistent with the level of complexation. Since Blend 1 to 5 contain the same grade and amount of PAE and glycerol, the difference in film softness is mainly due to the presence of polyelectrolyte complex and its level. This indicates that the complexation interaction can be used as additional factor to tune film softness of the creping adhesive. For Blend 5 at the retained film moisture higher than 3%, its film softness appears even comparable to Blend 6 which was composed of PAE, sulfonated PVOH and glycerol. Given the large softness difference between PVOH and polyacrylamide at comparable retained moisture levels, the comparable film softness between Blend 5 and Blend 6 suggests the magnitude of film softness that polyelectrolyte complexation can be used to tune the creping adhesive.

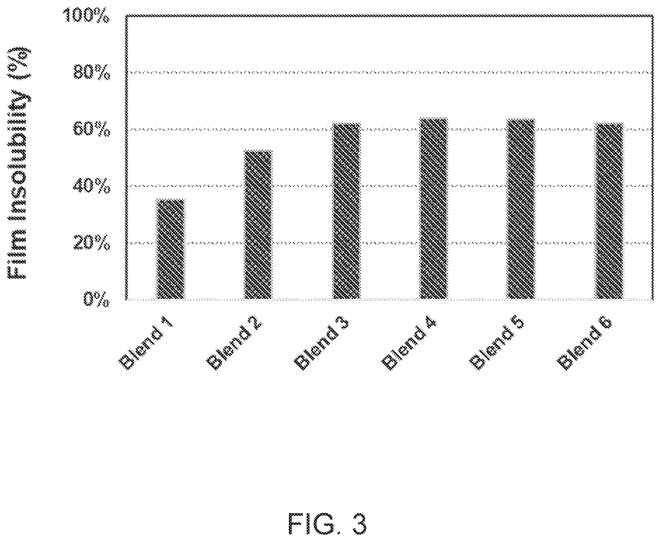

FIG. 3 shows film insolubility of the same 6 polymer blends as FIG. 2. This data provides a comparison of film durability of polyelectrolyte complex composed of PAE and sulfonated polyacrylamide (Blend 2 to 5) with non-complex adhesive (Blend 1) as well as polyelectrolyte complex composed of PAE and sulfonated PVOH (Blend 6). The blend 1 exhibits the lowest film insolubility, indicating this creping adhesive is the least durable. As polyelectrolyte complex forms and increases in the level, film insolubility increases from <40% for Blend 1 to >60% for Blend 3 and then plateaus for Blend 4 to Blend 5 which has comparable film insolubility to Blend 6. This suggests polyelectrolyte complexation and its level can also be used to tune film durability of the creping adhesive.

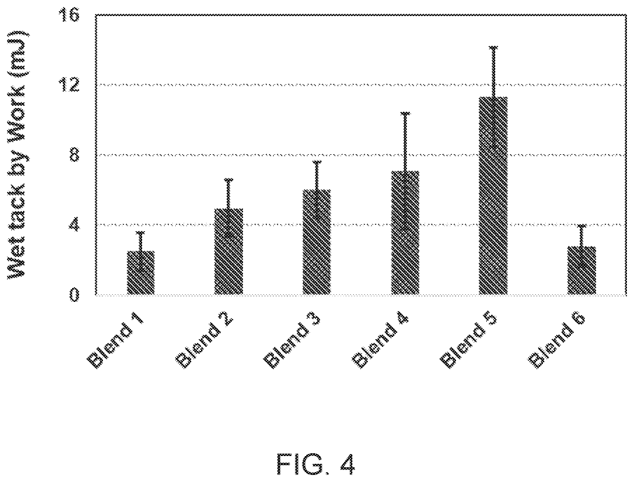

FIG. 4 shows wet tack of the same 6 polymer blends as FIGS. 2 and 3 with the adhesive retained moisture of about 40%. This data provides comparison of wet tack of polyelectrolyte complex composed of PAE and sulfonated polyacrylamide (Blend 2 to 5) with non-complex adhesive (Blend 1) as well as polyelectrolyte complex composed of PAE and sulfonated PVOH (Blend 6). At this adhesive retained moisture level, wet tack of the 6 blends ranks by Blend 1≈Blend 6<Blend 2<Blend 3<Blend 4<Blend 5, which is also consistent with the level of polyelectrolyte complexation. This suggests polyelectrolyte complexation and its level can also be used to tune wet tack of the creping adhesive.

### Example 3

### Comparison of Properties of Polyelectrolyte Complex Composed of PAE and Anionic Polyacrylamide with Different Anionic Chemistry

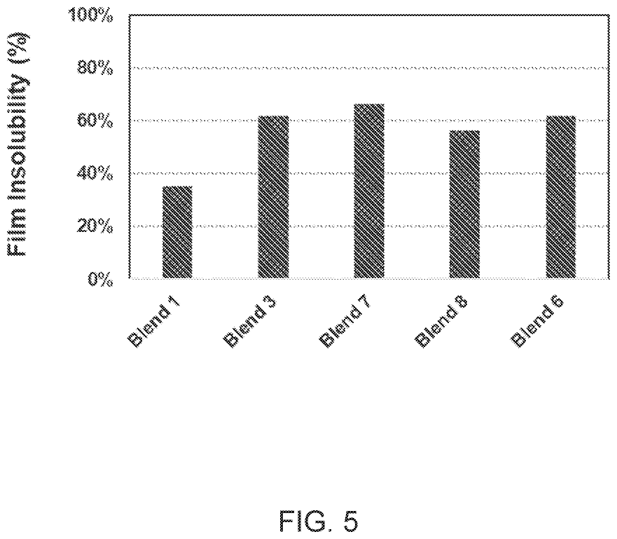

FIG. 5 shows film insolubility of 3 polymer blends composed of PAE, glycerol and anionic polyacrylamide with different anionic chemistry. Blend 3 contains sulfonated polyacrylamide; Blend 7 contains carboxylated polyacrylamide; and Blend 8 contains sulfonated and phosphated polyacrylamide. In combination with Blend 1 and Blend 6, this data provides comparison of influence of anionic group chemistry on complexation interaction and their effectiveness in improving film durability. The comparable film insolubility of Blend 3, Blend 7, and Blend 8 to Blend 6 indicates that the complexation interaction has little influence from anionic group chemistry. As long as the comparable level of complex forms, they are equally effective in improving film durability.

### Example 4

### Polyelectrolyte Complex Composed of PAE and Ligno-SO₃Na

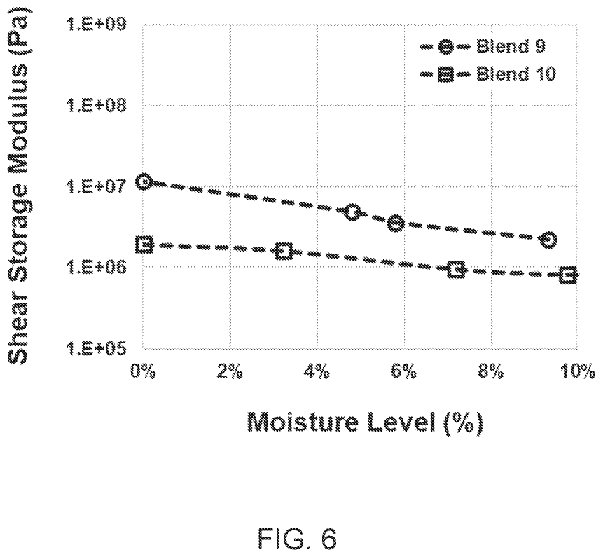

FIG. 6 shows shear storage modulus of Blend 9 composed of PAE, Ligno-SO₃Na and glycerol and Blend 10 composed of PAE and glycerol at the adhesive retained moisture range from 0 to 10%. Due to the low molecular weight, Ligno-SO₃Na alone forms a very brittle film with little mechanical strength and thus cannot even be evaluated for film softness using our test method. The PAE resin blended with glycerol (Blend 10) forms a film which is too soft. When PAE and Ligno-SO₃Na were blended and formed a polyelectrolyte complex at the right level, the film turns out to be much harder than the individual components and thus glycerol is used to tune the film to have the desirable softness at the target retained moisture range. This data demonstrates that film softness of a polyelectrolyte complex can not only be tuned to be softer compared to a non-complex blend but also be tuned to be harder than its starting components.

### Example 5

### Polyelectrolyte Complex Composed of Polyamidoamine and Sulfonated Polyacrylamide

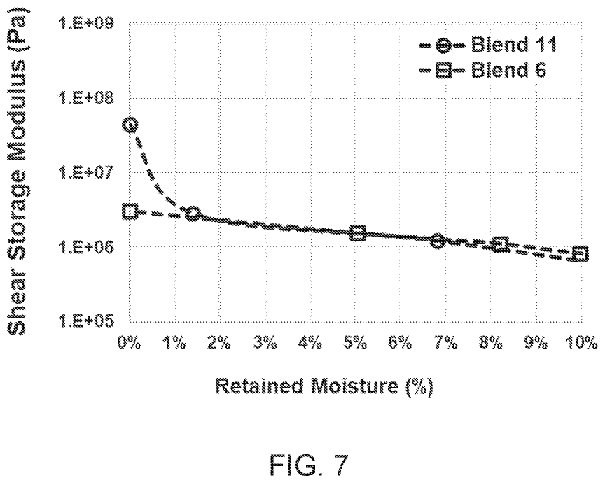

FIG. 7 shows shear storage modulus of Blend 11 composed of polyamidoamine, glycerol and sulfonated polyacrylamide at the adhesive retained moisture range from 0 to 10%. The polyamidoamine resin is a very low molecular weight polymer and forms a film which is too soft to be measured using our test method. When it was blended with sulfonated polyacrylamide and formed a polyelectrolyte complex, in the presence of glycerol, the film softness of the complex can be tuned to be comparable to the Blend 6.

### Example 6

### Role of Glycerol

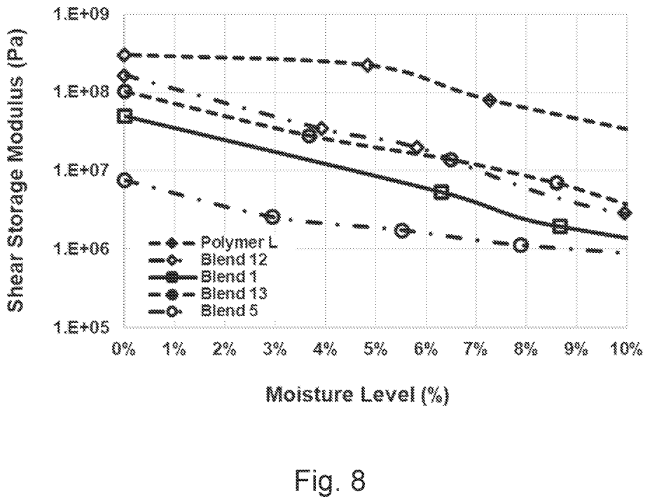

FIG. 8 compares shear storage modulus of polyacrylamide (Polymer L), Blend 12 (non-complex blend), Blend 1 (non-complex blend with glycerol), Blend 13 (complex blend), and Blend 5 (complex blend with glycerol) at the adhesive retained moisture range from 0 to 10%. Polymer L alone forms a very hard film and thus cannot function as a creping adhesive. Blending PAE with this polymer helps make Blend 12 much softer than Polymer L, but the blend is still too hard to function as a creping adhesive. Addition of glycerol further reduces film softness, but it is still not soft enough. Blending PAE with Polymer F makes Blend 13 to have a comparable film softness to Blend 12. However, upon addition of the same amount of glycerol, the film softness of Blend 5 becomes much lower than Blend 13 and Blend 1. In addition, the film softness also becomes less sensitive to the moisture change. This data demonstrates that the synergy between polyelectrolyte complex and the humectant has a much stronger influence on film softness thus can serve as additional tuning parameter for tailoring creping adhesive properties with desirable balance over coating adhesion, softness, and durability that can provide good creping quality over a wider operation window.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polyelectrolyte” is intended to include “at least one polyelectrolyte” or “one or more polyelectrolytes.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim. The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A papermaking creping adhesive, comprising:
one or more anionic polyelectrolytes selected from the group consisting of:
a sulfonated polyacrylamide, phosphonated polyacrylamide, carboxylated polyacrylamide, polyacrylic acid, sodium polyacrylate, sodium poly(styrenesulfonate), polyphosphate, lignosulfonate, carboxymethyl cellulose, and any combination thereof; and
one or more cationic polyelectrolytes selected from the group consisting of: polyamidoamine, polyamidoamine-epihalohydrin (PAE), crosslinked polyamidoamine, poly(allylamine), poly(allylamine)-epihalohydrin, crosslinked poly(allylamine), polyethyleneimine, polyvinylpyrrolidone, chitosan, poly(diallyldimethyl ammonium chloride), hydrolyzed poly(n-vinyl formamide), cationic polyacrylamide, and any combination thereof.

2. The papermaking creping adhesive of claim 1, wherein the anionic polyelectrolyte has a weight average molecular weight of about 500 Da to about 1,500 kDa.

3. The papermaking creping adhesive of claim 1, wherein the cationic polyelectrolyte has a weight average molecular weight of about 500 Da to about 1,500 kDa.

4. The papermaking creping adhesive of claim 1, wherein the papermaking creping adhesive has a shear storage modulus of about 1.0×10⁵ to about 5.0×10⁹ Pa at 100° C. with a retained moisture level of about 16% to about 0%.

5. The papermaking creping adhesive of claim 1, wherein the creping adhesive comprises about 0.001 wt % to about 99.9 wt % of the anionic polyelectrolyte, and about 0.001 wt % to about 99.9 wt % of the cationic polyelectrolyte, based on a combined weight of the adhesive polymers.

6. The papermaking creping adhesive of claim 1, wherein the papermaking creping adhesive does not include a polyvinyl alcohol.

7. The papermaking creping adhesive of claim 1, further comprising a plasticizer, wherein the plasticizer is a water soluble polyol, glycol, glycerol, sorbitol, polyglycerin, polyethylene glycol, sugar, oligosaccharide, hydrocarbon oil, or any mixture thereof.

8. The papermaking creping adhesive of claim 1, wherein the anionic polyelectrolyte comprises a sulfonated polyacrylamide polymer, and the cationic polyelectrolyte comprises a polyamidoamine-epichlorohydrin resin.

9. The papermaking creping adhesive of claim 8, wherein the polyamidoamine-epichlorohydrin resin has a weight average molecular weight of about 25 kDa to about 1,500 kDa.

10. The papermaking creping adhesive of claim 1, wherein the anionic polyelectrolyte comprises a sulfonated polyacrylamide.

11. The papermaking creping adhesive of claim 8, wherein the sulfonated polyacrylamide is a copolymer comprising acrylamide and 2-acrylamido-2-methylpropane sulfonic acid (AMPS).

12. The papermaking creping adhesive of claim 11, wherein the sulfonated polyacrylamide comprises about 1 wt % to about 99 wt % of AMPS.

13. The papermaking creping adhesive of claim 1, wherein the anionic polyelectrolyte comprises a lignosulfonate.

14. The papermaking creping adhesive of claim 1, wherein the anionic polyelectrolyte comprises a copolymer comprising acrylate and acrylamide.

15. The papermaking creping adhesive of claim 1, wherein the anionic polyelectrolyte comprises a polyphosphate.

16. A polyelectrolyte complex film comprising the papermaking creping adhesive of claim 1.

17. The polyelectrolyte complex film of claim 16, wherein the polyelectrolyte complex film has a film insolubility of about 10% to about 95%.

18. The polyelectrolyte complex film of claim 16, wherein the polyelectrolyte complex film has wet tack of about 1 mJ to about 50 mJ.

19. A polyelectrolyte complex film, comprising:
one or more anionic polyelectrolytes; and one or more cationic polyelectrolytes; wherein the polyelectrolyte complex film has a film insolubility of about 10% to about 95%.

20. A process for drying a paper web, comprising:
applying to a drying cylinder a papermaking creping adhesive; pressing the paper web against the drying cylinder to adhere the paper web to the drying cylinder; and dislodging the paper web from the drying cylinder with a doctor blade, wherein the papermaking dryer comprises a polyelectrolyte complex comprising one or more anionic polyelectrolytes, and one or more cationic polyelectrolytes.
